(19) United States
(12) Patent Application Publication
(10) Pub. No.: US 2005/0089359 A1
(43) Pub. Date: Apr. 28, 2005

(54) Liquid lipstick device having sealing cap

(76) Inventor: Jerry Chen, Tainan City (TW)

Correspondence Address: CHARLES E. BAXLEY, ESQUIRE, Third Floor, 90 John Street, New York, NY, 10038, US

(21) Appl. No.: 10/693,094

(22) Filed: Oct. 23, 2003

(51) Int. Cl. B05C 11/00; B43K 5/06; B43K 1/06

(52) U.S. Cl. 401/266; 401/265; 401/176

(57) ABSTRACT

A liquid lipstick dispensing device includes a container for receiving lipstick material, a piston for forcing the lipstick material to flow out of the container, and a control ferrule may be used for moving the piston relative to the container to force the lipstick material out of the container. A housing is attached to the container, a barrel is received in the housing and having a passage to allow the lipstick material to flow out of the container through the passage of the barrel. The barrel includes a peripheral flange extended radially out to engage with the inner peripheral surface of the container, and to make a water tight seal between the barrel and the container.

### BACKGROUND OF THE INVENTION

1. Field of the Invention

The present invention relates to a lipstick container device, and more particularly to a liquid lipstick device having a sealing cap for preventing the liquid-state or pasty-like lipstick from flowing out of the container.

2. Description of the Prior Art

The most typical lipsticks comprise a solid barrel-shaped lipstick retractably received in a container, and movable out of the container by a rotatable knob, with such as a helical-moving structure, and selectively receivable into the container by rotating the rotatable knob or the like.

The other typical lipstick devices comprise a liquid-state, or pasty-like lipstick material received within a container, and comprise a cap for enclosing the container, in order to enclose the container, and to retain the liquid-state, or pasty-like lipstick material within the container.

Normally, the cap is engageable onto the container, in order to retain the liquid-state, or pasty-like lipstick material within the container, and to prevent the liquid-state, or pasty-like lipstick material from flowing out of the container.

However, the caps of the typical lipstick devices are simply engaged within the front end of the container, such that the liquid-state, or pasty-like lipstick material may have a good chance to flow out through the gaps formed between the container and the cap, due to the capillary action, before the typical lipstick devices are opened and used by the users. The outward flowing of the liquid-state, or pasty-like lipstick material may spoil the products of the typical lipstick devices, and will not be purchased by the customers.

The present invention has arisen to mitigate and/or obviate the afore-described disadvantages of the conventional liquid lipstick devices.

### SUMMARY OF THE INVENTION

The primary objective of the present invention is to provide a liquid lipstick dispensing device having a sealing cap for preventing the liquid-state or pasty-like lipstick from flowing out of the container.

In accordance with one aspect of the invention, there is provided a liquid lipstick dispensing device comprising a container including a chamber formed therein to receive lipstick material therein and defined by an inner peripheral surface, and including a lower portion, a piston slidably received in the chamber of the container and engageable with the lipstick material, for forcing the lipstick material to flow out of the container, means for moving the piston relative to the container to force the lipstick material out of the container, and a mouth including a housing attached to the lower portion of the container, to receive the lipstick material and to allow the lipstick material to flow out of the container via the mouth. The housing includes a bore formed therein, the mouth further includes a barrel received in the bore of the housing and having a passage formed therein for allowing the lipstick material to flow out of the container through the passage of the barrel, the barrel includes a peripheral flange extended radially out therefrom to engage with the inner peripheral surface of the container, and to make-a water tight seal between the barrel and the container.

The barrel includes an inclined surface formed on formed in an outer peripheral portion thereof, for engaging with the inner peripheral surface of the container.

The container includes at least one peripheral groove formed therein, the housing includes at least one peripheral rib extended therefrom, for engaging into the at least one peripheral groove of the container, and for securing the housing to the container. The barrel includes a peripheral hub extended upwardly therefrom to define the passage thereof.

The housing includes a peripheral swelling extended radially inward therefrom, the barrel includes a shank having a decreased outer diameter and engaged through the peripheral swelling of the housing, and extended into the housing, to form a shoulder therein, and to engage with the peripheral swelling of the housing, to anchor the barrel to the housing.

The mouth further includes a cap attached to the housing and having a space formed therein, the cap includes a perforated member to dispense the lipstick material. The housing includes a peripheral slot formed therein, the cap includes a peripheral rib extended radially out therefrom to engage into the peripheral slot of the housing, and to anchor the cap to the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a liquid lipstick dispensing device in accordance with the present invention;

FIG. 2 is a partial exploded view of the liquid lipstick dispensing device;

FIG. 3 is an exploded view of a mouth of the liquid lipstick dispensing device;

FIG. 4 is a partial cross sectional view taken along lines 4-4 of FIG. 2; and

FIG. 5 is an enlarged partial cross sectional view of the mouth of the liquid lipstick dispensing device.

### DETAILED DESCRIPTION OF THE PREFERRED EMBODIMENT

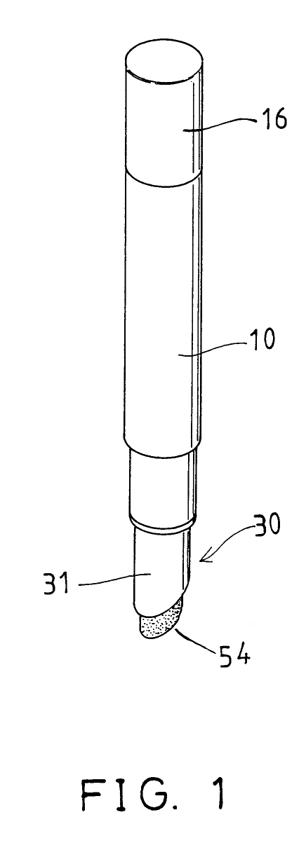

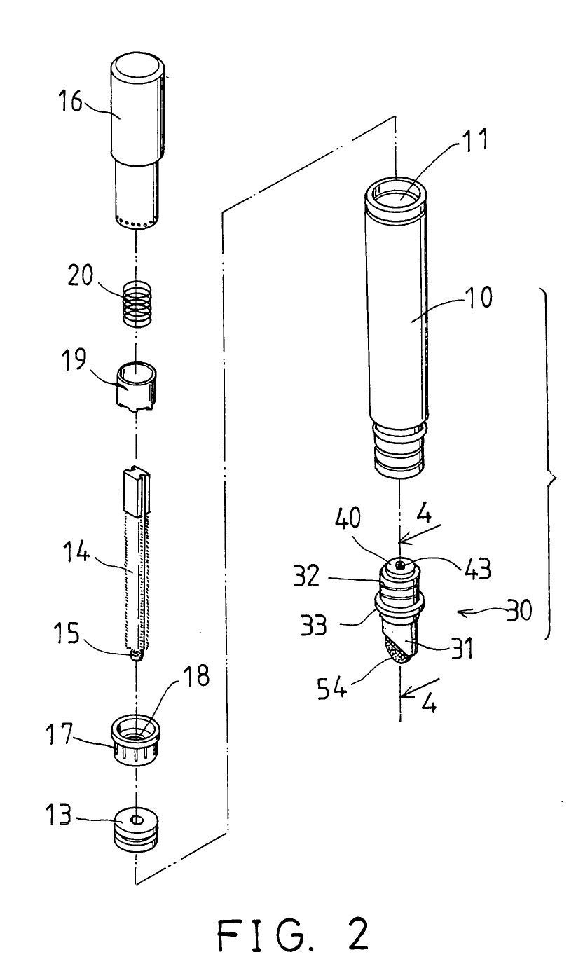

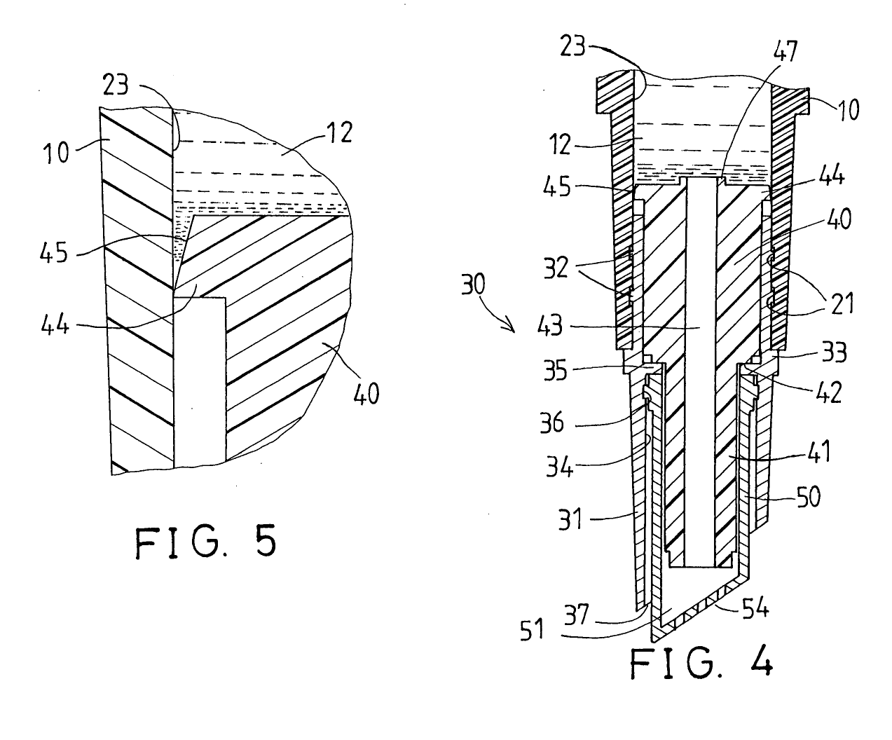

Referring to the drawings, and initially to FIGS. 1 and 2, a liquid lipstick dispensing device in accordance with the present invention comprises a container 10 including a chamber 11 formed therein for receiving a liquid-state, or pasty-like lipstick material 12 therein (FIGS. 4, 5). A piston 13 is slidably engaged in the chamber 11 of the container 10, and engageable with the liquid-state, or pasty-like lipstick material 12, for forcing the lipstick material 12 out of the container 10.

A stem 14 is slidably received in the container 10, and includes a lower catch 15 engaged into the piston 13, and secured to the piston 13 by such as force-fitted engagements, adhesive materials, or by welding processes, such that the piston 13 may be moved along the container 10 by the stem 14, to force the lipstick material 12 out of the container 10, when required.

A control ferrule 16 is partially and rotatably engaged in the chamber 11 of the container 10, and secured to the stem 14, for rotating the stem 14 relative to the container 10, but for allowing the stem 14 to be moved longitudinal relative to the control ferrule 16. A duct 17 may be secured within the container 10 with such as force-fitted engagements, latches, adhesive materials, or by welding processes, and will not be moved or rotated relative to the container 10.

The duct 17 includes an inner thread 18 formed therein for threading with the stem 14, and for moving the stem 14 along the container 10 longitudinally when the stem 14 is rotated relative to the duct 17 and the container 10 with the control ferrule 16, and thus for moving or forcing the liquid-state, or pasty-like lipstick material 12 out of the container 10. A sleeve 19 is rotatably engaged onto the stem 14, and solidly secured to the control ferrule 16 and rotated in concert with the control ferrule 16.

The sleeve 19 and the duct 17 may be provided and used for preventing the control ferrule 16 from being rotated reversely relative to the container 10, and for guiding the control ferrule 16 to be rotated in an action direction only, and thus for allowing the liquid-state, or pasty-like lipstick material 12 to be gradually forced out of the container 10 by the control ferrule 16. A spring 20 may be engaged between the sleeve 19 and the control ferrule 16, to force or bias the sleeve 19 to engage with the duct 17. The above-described structure of the liquid lipstick dispensing device is typical and will not be described in further details.

A mouth 30 is further provided for attaching to the lower portion of the container 10, and for controlling the outward flowing of the liquid-state, or pasty-like lipstick material 12 relative to the container 10.

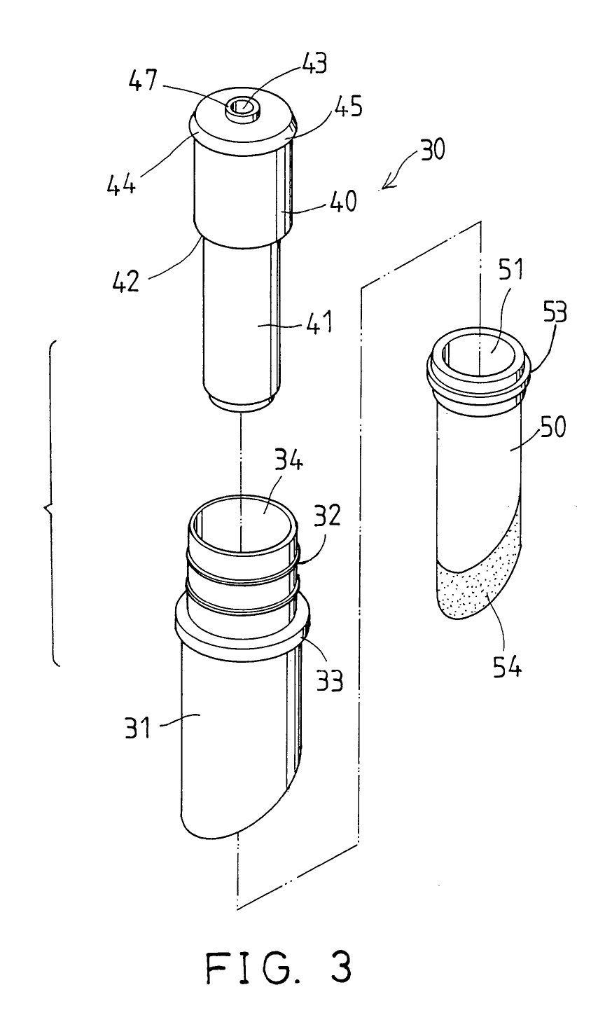

Referring next to FIGS. 3 and 4, the mouth 30 includes a housing 31 including a helical rib or one or more peripheral ribs 32 provided on or extended out of the outer peripheral portion of the upper portion thereof, for engaging into corresponding helical groove or one or more peripheral grooves 21 (FIG. 4) that are formed within the container 10, for attaching or securing the housing 31 to the lower portion of the container 10.

The housing 31 includes a peripheral bulge 33 extended radially outward from the middle portion thereof, for engaging with the lower portion of the container 10 (FIG. 4), and for positioning or anchoring the housing 31 to the container 10; and includes a bore 34 formed therein, and includes a peripheral swelling 35 extended radially inward of the middle portion of the bore 34 thereof, and a peripheral slot 36 formed in the middle portion thereof, and includes a lower opening 37 formed therein.

A barrel 40 is received in the bore 34 of the housing 31, and includes a shank 41 having a decreased outer diameter and engaged through the peripheral swelling 35 of the housing 31, and extended into the lower portion of the bore 34 of the housing 31, in order to form or define a shoulder 42 in the middle portion thereof. The shoulder 42 of the barrel 40 may be engaged with the peripheral swelling 35 of the housing 31, for positioning or anchoring the barrel 40 to the housing 31.

The barrel 40 includes a passage 43 formed therein for allowing the liquid-state, or pasty-like lipstick material 12 to flow out of the container 10 through the passage 43 of the barrel 40 of the mouth 30. The barrel 40 further includes a peripheral flange 44 extended radially and outwardly from the upper portion thereof, for engaging with the inner peripheral surface 23 of the container 10 (FIGS. 4, 5), and for making a water tight seal between the barrel 40 and the container 10.

It is preferable that the peripheral flange 44 of the barrel 40 includes a tapered or inclined surface 45 formed in the outer peripheral portion thereof, for making a force-tight engagement with the inner peripheral surface 23 of the container 10, best shown in FIG. 5, and for facilitating the water tight seal between the barrel 40 and the container 10, and thus for preventing the liquid-state, or pasty-like lipstick material 12 from permeating or flowing out through the gap formed between the housing 31 and the container 10. It is preferable that the barrel 40 includes a peripheral hub 47 extended upwardly therefrom for defining the passage 43 thereof.

A cap 50 includes a space 51 formed therein for receiving the lower shank 41 of the barrel 40, and includes a peripheral rib 53 extended radially and outwardly from the upper portion thereof, for engaging into the peripheral slot 36 of the housing 31, and for anchoring or securing the cap 50 to the housing 31. The cap 50 may include a spongy material or perforated member 54 attached to the free or bottom end thereof, to absorb and to dispense the liquid-state, or pasty-like lipstick material 12. A cover (not shown) may further be provided and attached to the bottom portion of the container 10, to shield the cap 50 of the mouth 30.

In operation, as shown in FIGS. 4 and 5, the spongy material or perforated member 54 of the cap 50 of the mouth 30 may be used to absorb and retain the liquid-state, or pasty-like lipstick material 12 within the cap 50, and to dispense the liquid-state, or pasty-like lipstick material 12 when the liquid-state, or pasty-like lipstick material 12 is forced out of the container 10 and the barrel 40 by the piston 13 and the control ferrule 16.

The provision and the engagement of the peripheral flange 44 of the barrel 40 with the inner peripheral surface 23 of the container 10, may make and facilitate the water tight seal between the barrel 40 and the container 10, and thus for preventing the liquid-state, or pasty-like lipstick material 12 from permeating or flowing out through the gap formed between the housing 31 and the container 10.

Accordingly, the liquid lipstick dispensing device in accordance with the present invention includes a sealing barrel for preventing the liquid-state or pasty-like lipstick from flowing out of the container.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A liquid lipstick dispensing device comprising:
a container including a chamber formed therein to receive lipstick material therein and defined by an inner peripheral surface, and including a lower portion,
a piston slidably received in said chamber of said container and engageable with said lipstick material, for forcing said lipstick material to flow out of said container,
means for moving said piston relative to said container to force said lipstick material out of said container, and
a mouth including a housing attached to said lower portion of said container, to receive said lipstick material and to allow said lipstick material to flow out of said container via said mouth, said housing including a bore formed therein, said mouth further including a barrel received in said bore of said housing and having a passage formed therein for allowing said lipstick material to flow out of said container through said passage of said barrel, said barrel including a peripheral flange extended radially out therefrom to engage with said inner peripheral surface of said container, and to make a water tight seal between said barrel and said container.

2. The liquid lipstick dispensing device as claimed in claim 1, wherein said barrel includes an inclined surface formed on formed in an outer peripheral portion thereof, for engaging with said inner peripheral surface of said container.

3. The liquid lipstick dispensing device as claimed in claim 1, wherein said container includes at least one peripheral groove formed therein, said housing includes at least one peripheral rib extended therefrom, for engaging into said at least one peripheral groove of said container, and for securing said housing to said container.

4. The liquid lipstick dispensing device as claimed in claim 1, wherein said barrel includes a peripheral hub extended upwardly therefrom to define said passage thereof.

5. The liquid lipstick dispensing device as claimed in claim 1, wherein said housing includes a peripheral swelling extended radially inward therefrom, said barrel includes a shank having a decreased outer diameter and engaged through said peripheral swelling of said housing, and extended into said housing, to form a shoulder therein, and to engage with said peripheral swelling of said housing, to anchor said barrel to said housing.

6. The liquid lipstick dispensing device as claimed in claim 1, wherein said mouth further includes a cap attached to said housing and having a space formed therein, said cap includes a perforated member to dispense said lipstick material.

7. The liquid lipstick dispensing device as claimed in claim 6, wherein said housing includes a peripheral slot formed therein, said cap includes a peripheral rib extended radially out therefrom to engage into said peripheral slot of said housing, and to anchor said cap to said housing.
